(19) United States
(12) Patent Application Publication
(10) Pub. No.: US 2025/0021917 A1
(43) Pub. Date: Jan. 16, 2025

(54) EVALUATION APPARATUS, SYSTEM, METHOD, AND PROGRAM

(71) Applicant: NEC Communication Systems, Ltd., Minato ku, Tokyo (JP)

(72) Inventors: Akira MATSUMOTO, Tokyo (JP); Momo Suto, Tokyo (JP); Kenichi Abe, Tokyo (JP); Chikashi Ito, Tokyo (JP); Tetsuya Ito, Tokyo (JP); Norihiko Kamata, Tokyo (JP); Masakazu Kaneda, Tokyo (JP); Satoki Ueno, Tokyo (JP)

(73) Assignee: NEC Communication Systems, Ltd., Minato-ku, Tokyo (JP)

(21) Appl. No.: 18/714,253

(22) PCT Filed: Dec. 16, 2022
(86) PCT No.: PCT/JP2022/046363

§ 371 Date: May 29, 2024

(30) Foreign Application Priority Data
Dec. 17, 2021 (JP) 2021-205580

(51) Int. Cl. G06Q 10/0639; G06Q 50/02

(52) U.S. Cl. CPC G06Q 10/06395; G06Q 50/02

(57) ABSTRACT

An evaluation apparatus includes: an evaluation method acquisition part configured to acquire evaluation method data from an evaluation method provision apparatus; an evaluation criteria creation part configured to create evaluation criteria information for evaluating collected information that integrates data collected from a field management system that manages field information based on the evaluation method data; an evaluation processing part configured to evaluate the collected information based on the evaluation criteria information and create an evaluation result.

This application is a National Stage Entry of PCT/JP2022/046363 filed on Dec. 16, 2022, which claims priority from JP Patent Application 2021-205580 filed on Dec. 17, 2021, the contents of all of which are incorporated herein by reference, in their entirety.

### FIELD

### Description of Related Application

The present invention is based on claiming priority of Japanese Patent Application: JP2021-205580 (filed on Dec. 17, 2021), the entire contents of the present application shall be incorporated and stated in the present application by reference thereto.

The present invention relates to an evaluation apparatus, a system, a method, and a program.

### BACKGROUND

In recent years, in order to ensure safety and security of domestic animals (livestock) for meat, evaluations (determinations, estimations, etc.) relating to health, rearing, and environment have been conducted based on information relating to domestic animals, and attempts are being made to automate these evaluations (see Patent Literatures (PTLs) 1 to 3).

For example, PTL 1 discloses a system that comprises: receiving information for identification production area of a determination target cow (stable isotope ratio data, fatty acid composition data, inorganic trace element data and image analysis data, and sensory evaluation data when eating the determination target cow, included in the determination target cow); and determining the production area of the determination target cow based on information in a production area database of cows.

Also, PTL 2 discloses a system that comprises: estimating individual growth information (movement amount, weight, etc.) of domestic animals based on images of the domestic animals; and determining whether or not each of health condition of the domestic animals is abnormal based on the estimated individual growth information.

Further, PTL 3 discloses a system that estimates conditions of domestic animals based on power generation information generated by a power generation part in a sensor apparatus attached to the domestic animals.
[PTL 1] JP2021-140773A
[PTL 2] JP2021-103352A
[PTL 3] WO2016/181604A1
[NPTL 1] “Animal welfare evaluation method for dairy cows: Revised on Sep. 11, 2021 (PDF)”, http://animalwelfare.jp/wp-content/uploads/2021/09/EvaluationCriteriaCOW_2021.pdf

### SUMMARY

The following analysis is provided by the inventors.

By the way, in recent years, concept of animal welfare, which raises and manages domestic animals by raising domestic animals in a comfortable environment to reduce stress and disease in domestic animals, is becoming popular due to efforts of World Organization for Animal Health, Ministry of Agriculture, Forestry and Fisheries, and General Incorporated Association Animal Welfare Livestock Association. In the animal welfare, evaluation methods have been created for the physical and mental conditions of animals related to environment related to animal life and death (see Non-Patent Literature (NPTL) 1). Besides animal welfare, evaluation methods relating to grass-fed (breeding on grass), cage-free (breeding chickens open-space breeding or pasturage), organic (breeding without relying on pesticides or chemical fertilizers), and carbon farming (farm management that stably suppresses CO₂ emissions and fixes CO₂ in soil and plants), etc. are also being standardized.

However, the systems described in PTLs 1 to 3 collect specific information and evaluate unique production areas, health conditions, domestic animal conditions, etc., so there is a possibility that it will not be possible to conduct an objective evaluation so that the safety and security of domestic animals for meat can be ensured. In other words, the current system may not be able to conduct sufficient evaluations corresponding to a demand of changing standardized evaluation method. The same can be said not only in the field of domestic animals but also in other industrial fields, etc.

It is a main objective of the present invention to provide an evaluation apparatus, a system, a method, and a program that can contribute to conducting evaluation corresponding to a demand of changing standardized evaluation method.

An evaluation apparatus according to a first aspect comprises: an evaluation method acquisition part configured to acquire evaluation method data from an evaluation method provision apparatus: an evaluation criteria creation part configured to create evaluation criteria information for evaluating collected information that integrates data collected from a field management system that manages field information based on the evaluation method data; and an evaluation processing part configured to evaluate the collected information based on the evaluation criteria information and create an evaluation result.

An evaluation system according to a second aspect comprises: the evaluation apparatus according to the first aspect: a field management system that manages field information and is communicably connected to the evaluation apparatus: an evaluation method provision apparatus that provides evaluation method data and is communicably connected to the evaluation apparatus; and a viewing terminal communicably connected to the evaluation apparatus.

The evaluation system according to the third aspect comprises: the evaluation apparatus according to the first aspect: an information management apparatus that manages the collected information and is communicably connected to the evaluation apparatus: a field management system that manages field information and is communicably connected to the information management apparatus: an evaluation method provision apparatus that provides evaluation method data and is communicably connected to the evaluation apparatus; and a viewing terminal communicably connected to the information management apparatus.

The evaluation method according to the fourth aspect evaluates collected information using hardware resources, wherein the evaluation method comprises: acquiring evaluation method data from an evaluation method provision apparatus: creating evaluation criteria information for evaluating collected information that integrates data collected from a field management system that manages field information based on the evaluation method data; and evaluating the collected information based on the evaluation criteria information to create an evaluation result.

The program according to the fifth aspect is a program that causes hardware resources to execute processings for evaluating collected information, wherein the program that causes the hardware resources to execute processings: acquiring evaluation method data from the evaluation method provision apparatus: based on the evaluation method data, creating evaluation criteria information for evaluating collected information that integrates data collected from a field management system that manages field information; and evaluating the collected information based on the evaluation criteria information to create an evaluation result.

The program can be recorded on a computer-readable storage medium. The storage medium may be a non-transitory such as a semiconductor memory, a hard disk, a magnetic recording medium, or an optical recording medium. Also, in the present disclosure, it is also possible to implement it as a computer program product. The program is input to a computer apparatus from an input device or from outside via a communication interface: is stored in a storage device: causes a processor to drive according to predetermined steps or processings: can cause to display processing results thereof, including an intermediate state via a display device step by step as necessary: or can cause to communicate with outside via a communication interface. The computer apparatus for that purpose typically comprises: for example, a processor: a storage device: an input device: a communication interface; and, if necessary, a display device, that can be connected to each other via a bus.

According to the first to fifth aspects, it is possible to contribute to conducting evaluation corresponding to a demand of changing standardized evaluation method.

### BRIEF DESCRIPTION OF THE DRAWINGS

FIG. 1 is a block diagram schematically showing a configuration of an evaluation system according to an example embodiment 1.

FIG. 2 is a schematic diagram showing an example of evaluation method data provided by an evaluation method provision apparatus of the evaluation system according to the example embodiment 1.

FIG. 3 is a schematic diagram showing an example of evaluation criteria information created by an evaluation apparatus in the evaluation system according to the example embodiment 1.

FIG. 4 is a schematic diagram showing an example of collected information collected by the evaluation apparatus in the evaluation system according to the example embodiment 1.

FIG. 5 is a schematic diagram showing an example of evaluation result when an evaluation process is performed by the evaluation apparatus in the evaluation system according to the example embodiment 1.

FIG. 6 is a schematic diagram showing an example of visualization information created by the evaluation apparatus in the evaluation system according to the example embodiment 1.

FIG. 7 is a flowchart schematically showing operations when creating evaluation criteria information by the evaluation apparatus in the evaluation system according to the example embodiment 1.

FIG. 8 is a flowchart schematically showing operations when data collection and evaluation processing are performed by the evaluation apparatus in the evaluation system according to the example embodiment 1.

FIG. 9 is a flowchart schematically showing operations when providing information by the evaluation apparatus in the evaluation system according to the example embodiment 1.

FIG. 10 is a block diagram schematically showing a configuration of an evaluation system according to an example embodiment 2.

FIG. 11 is a block diagram schematically showing a configuration of an evaluation system according to an example embodiment 3.

FIG. 12 is a block diagram schematically showing a configuration of an evaluation system according to an example embodiment 4.

FIG. 13 is a block diagram schematically showing a configuration of an evaluation apparatus according to an example embodiment 5.

FIG. 14 is a block diagram schematically showing a configuration of hardware resources.

### EXAMPLE EMBODIMENTS

Hereinafter, example embodiments will be described with reference to drawings. It should be noted that when reference numerals are attached to the drawings in the present application, they are solely for a purpose of helping understanding, and are not intended to limit the example embodiments shown in the drawings. Also, the following example embodiments are only examples, and do not limit the present invention. Further, connection lines between blocks in the drawings and the like referred to in the following description include both bidirectional and unidirectional connections. The unidirectional arrows schematically show flows of main signals (data) and do not exclude bidirectionality. Furthermore, in circuit diagrams, block diagrams, internal configuration diagrams, connection diagrams, etc. disclosed in the present application, an input port and an output port exist at the input end and the output end of each connection line, respectively, although not explicitly shown. The same applies to input/output interface. The program is executed via a computer apparatus, and the computer apparatus comprises, for example, a processor, a storage device, an input apparatus, a communication interface, and a display apparatus as necessary. The computer apparatus is configured to be able to communicate with an internal or external apparatus (including computer) via the communication interface, irrespective of wired or wireless.

### Example Embodiment 1

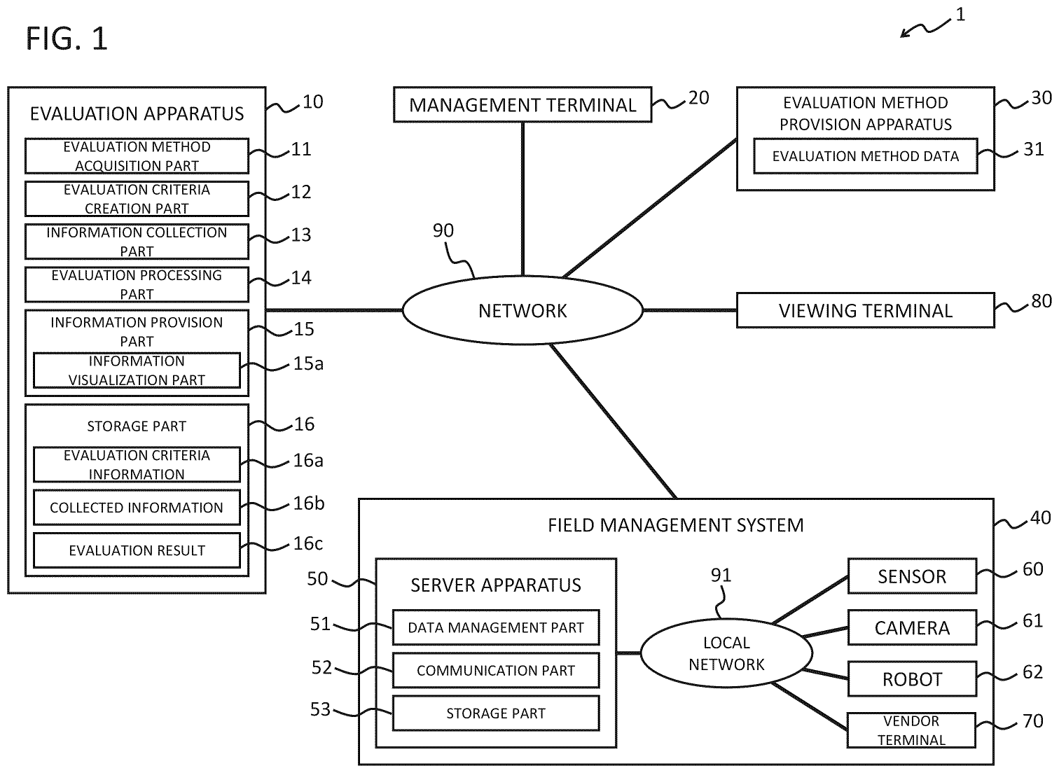

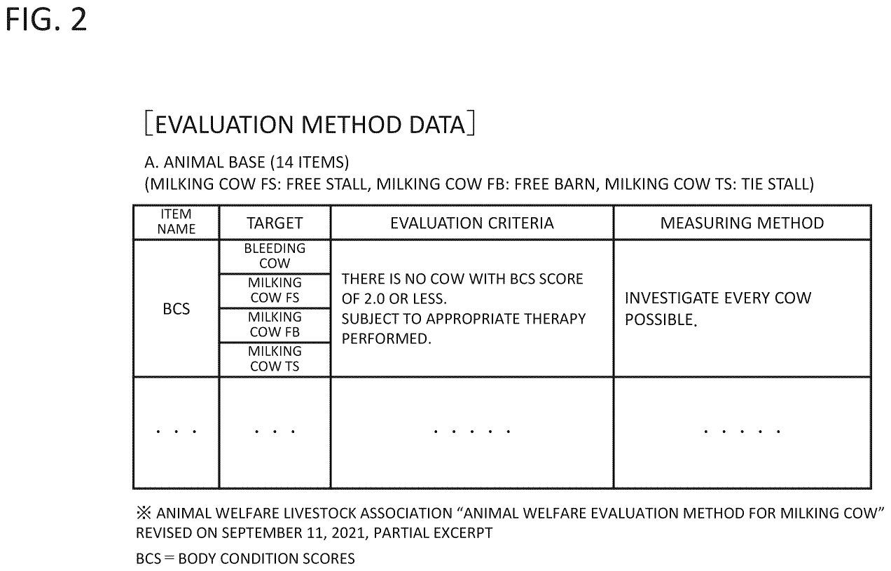

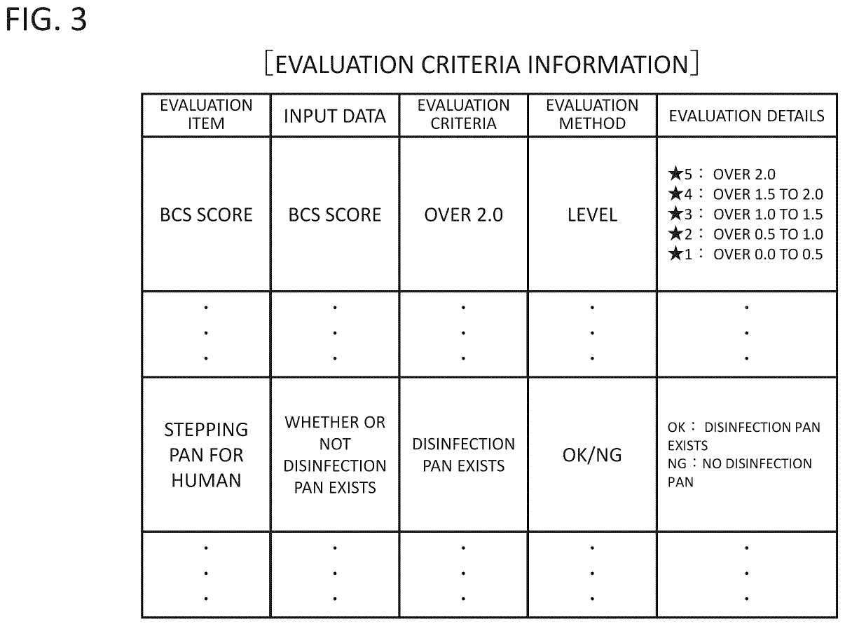

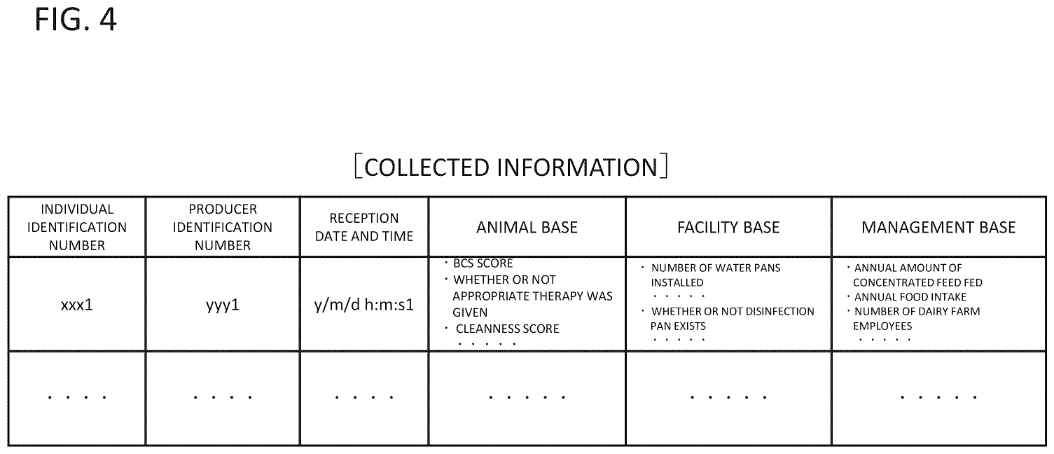

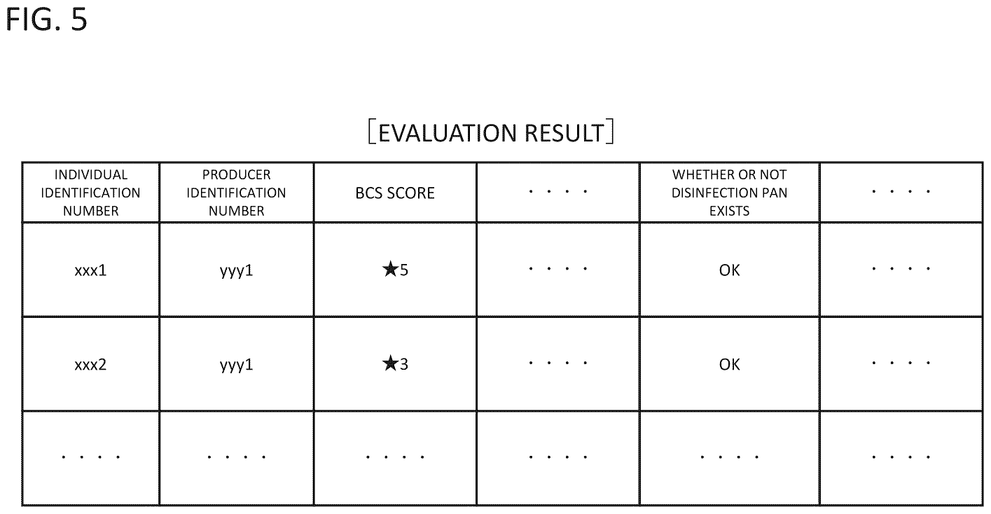

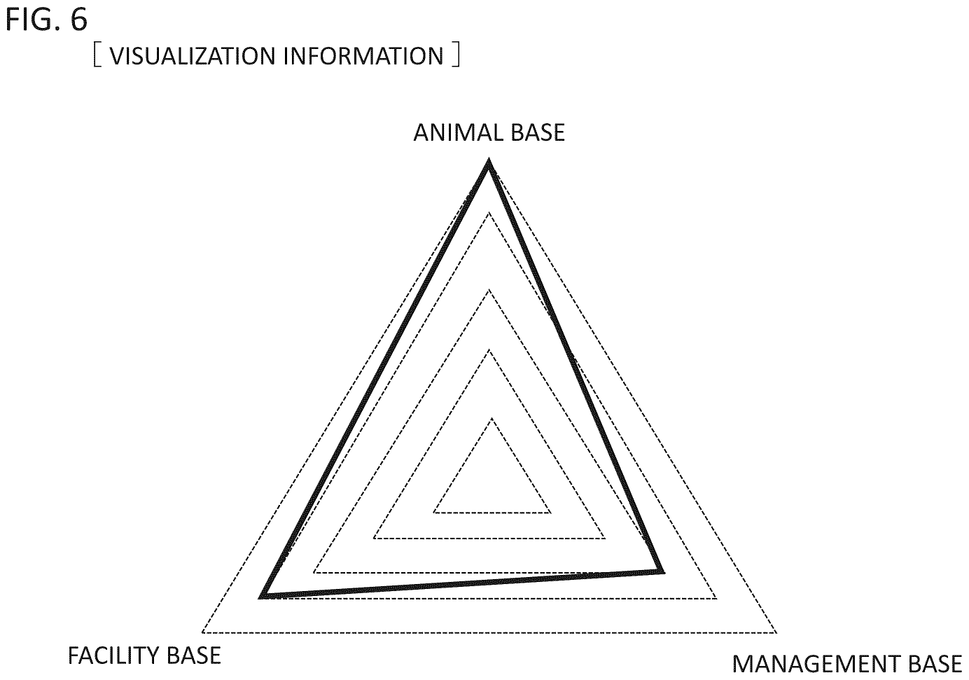

An evaluation system according to the example embodiment 1 will be explained using drawings. FIG. 1 is a block diagram schematically showing a configuration of the evaluation system according to the example embodiment 1. FIG. 2 is a schematic diagram showing an example of evaluation method data provided by an evaluation method provision apparatus of the evaluation system according to the example embodiment 1. FIG. 3 is a schematic diagram showing an example of evaluation criteria information created by an evaluation apparatus in the evaluation system according to the example embodiment 1. FIG. 4 is a schematic diagram showing an example of collected information collected by the evaluation apparatus in the evaluation system according to the example embodiment 1. FIG. 5 is a schematic diagram showing an example of evaluation result when evaluation processing is performed by the evaluation apparatus in the evaluation system according to the example embodiment 1. FIG. 6 is a schematic diagram showing an example of visualization information created by the evaluation apparatus in the evaluation system according to the example embodiment 1.

The evaluation system 1 is a system that evaluates an evaluation target object according to a standardized evaluation method (see FIG. 1). As the standardized evaluation method, for example, standardized evaluation methods related to animal welfare, grass-fed, cage-free, organic, carbon farming, etc., and standardized evaluation methods related to other industrial fields, factories, offices, housing, public facilities, gas/water, roads, railway lines, telephones, electricity, etc. can be used. As the evaluation target object, for example, a domestic animal, an object related to other industrial fields, facilities, environments, and the like can be used. The evaluation system 1 monitors standardized evaluation method data 31 (for example, see FIG. 2), acquires evaluation methods for new species (new domestic animal species, new breeds, etc.) and revised evaluation methods, and creates evaluation criteria information 16a (for example, see FIG. 3). The evaluation system 1 collects various types of data necessary for evaluation of each evaluation item of the created evaluation criteria information 16a: integrates and manages the collected data as collected information 16b (for example, see FIG. 4); and makes collected information 16b viewable. The evaluation system 1 creates an evaluation result 16c (for example, see FIG. 5) based on the collected information 16b that is integrated and managed, and makes the evaluation result 16c viewable. The evaluation system 1 creates visualization information (for example, see FIG. 6) that visualizes the evaluation result to be viewed, and makes visualization information viewable. The evaluation system 1 comprises, as main configuration, an evaluation apparatus 10, a management terminal 20, an evaluation method provision apparatus 30, a field management system 40, a viewing terminal 80, and a network 90.

The evaluation apparatus 10 is an apparatus that evaluates a state relating to the evaluation target object (for example, a domestic animal, etc.) (see FIG. 1). The evaluation apparatus 10 provides a scheme for utilizing the collected information 16b (for example, see FIG. 4) relating to the evaluation target object and the evaluation result 16c (for example, see FIG. 5) thereof. The evaluation apparatus 10 acquires evaluation method data 31 (see, for example, FIG. 4) from the evaluation method provision apparatus 30, and creates evaluation criteria information 16a (see, for example, FIG. 3) based on the acquired evaluation method data 31. The evaluation apparatus 10 collects data (corresponding to the input data in FIG. 3) necessary for each evaluation item in the evaluation criteria information 16a from the field management system 40, and stores the collected data as collected information 16b. The evaluation apparatus 10 creates an evaluation result 16c of the stored collected information 16b based on the created evaluation criteria information 16a and makes the collected information 16b and the evaluation result 16c viewable by way of the viewing terminal 80. As the evaluation apparatus 10, for example, a server apparatus comprising a computer including a processor, a memory, a network interface, etc. can be used. The evaluation apparatus 10 is communicably (wireless-communicably, wired-communicably) connected to the management terminal 20, the evaluation method provision apparatus 30, the field management system 40, and the viewing terminal 80 via a network 90. The evaluation apparatus 10 has a clock function that manages date and time. The evaluation apparatus 10 can be a configuration that virtually comprises an evaluation method acquisition part 11, an evaluation criteria creation part 12, an information collection part 13, an evaluation processing part 14, an information provision part 15 and a storage part 16, by executing a program in a processor while using a memory.

The evaluation method acquisition part 11 is a function part that acquires evaluation method data 31 from the evaluation method provision apparatus 30 (see FIG. 1). The evaluation method acquisition part 11 accesses the evaluation method provision apparatus 30 periodically (possibly at any time): acquires evaluation method data 31; compares the acquired evaluation method data 31 to evaluation method data acquired in the past: in case that the acquired evaluation method data 31 is a new type of evaluation method data or revised evaluation method data, stores the acquired evaluation method data 31 (for example, see FIG. 2) in the storage part 16 and transmits the evaluation method data 31 to the evaluation criteria creation part 12. In case that the acquired evaluation method data 31 is not a new type of evaluation method data or revised evaluation method data, since the evaluation criteria information 16a already exists, the evaluation method acquisition part 11 does not store the acquired evaluation method data 31 in the storage part 16 and does not transmit the evaluation method data 31 to the evaluation criteria creation part 12. In case that there is evaluation method data 31 to be wanted to acquire but there is not the evaluation method provision apparatus 30, the evaluation method acquisition part 11 may acquire the evaluation method data 31, input to the management apparatus 20, from the management apparatus 20.

Here, as the evaluation method data 31, data relating to the standardized evaluation method created by international organizations, public institutions, etc. can be used and, for example, data relating to the animal welfare evaluation method as shown in FIG. 2 can be used. The evaluation method data 31 is not limited to international or official data and may be a de facto standardized data.

The evaluation criteria creation part 12 is a function part that creates evaluation criteria information 16a for evaluating the collected information 16b collected from the field management system 40 based on the evaluation method data 31 acquired by the evaluation method acquisition part 11 (see FIG. 1). The evaluation criteria creation part 12 can create the evaluation criteria information 16a automatically or manually (input from the management terminal 20 of an administrator). The evaluation criteria creation part 12 may be such a configuration that extracts keywords from the evaluation method data 31: based on evaluation related keywords (for example, keywords related to evaluation items, input data, and evaluation criteria) obtained through machine learning, extracts keywords corresponding to the evaluation related keywords from among the extracted keywords; and, based on the keywords corresponding to the extracted evaluation related keywords, creates evaluation criteria information 16a as shown in FIG. 3. As to the evaluation method and evaluation content that are evaluated using a threshold value out of the evaluation method and evaluation content in the evaluation criteria information 16a, it is possible to set the evaluation method to a level and set the evaluation content to progressive levels so that a higher level is given as the percentage of achievement of the evaluation criteria increases. As to the evaluation method and evaluation content that are evaluated as YES/NO, it is possible to set the evaluation method to OK/NG and set the evaluation content to OK/NG. In case that there is a keyword that is not applicable to any of the evaluation related keywords in the extracted keywords, the evaluation criteria creation part 12 may notify the management terminal 20 used by the administrator of the evaluation apparatus 10 that there is an unapplicable keyword. As a result, the administrator can classify irrelevant keywords as to whether or not they are keywords related to evaluation items, input data, and evaluation criteria, and cause the evaluation criteria creation part 12 to perform machine learning using the management terminal 20. The evaluation criteria creation part 12 may create the evaluation criteria information 16a based on keywords related to the evaluation items, input data and the evaluation criteria assigned by the administrator. Also, the evaluation criteria creation part 12 may extract differences between the previous evaluation method data 31 and the current evaluation method data 31, and, in case that there is a change point, notify the change point to the management terminal 20 used by the administrator of the evaluation apparatus 10. The evaluation criteria creation part 12 causes the storage part 16 to store the created evaluation criteria information 16a.

The information collection part 13 is a function part that collects data corresponding to preset collection items from the field management system 40 (see FIG. 1). The information collection part 13 provides information relating to the collection items to the server apparatus 50 of the field management system 40. The collected data includes identification information (for example, individual identification number, producer identification number, etc.), and the date and time of reception when received by the evaluation apparatus 10 (see FIG. 4; “y/m/d h:m:s” means “year/month/day hour:minute:second”) is added to the collected data. When the information collection part 13 is unable to collect data according to the collection items from the field management system 40, the information collection part 13 may notify the field management system 40 to transmit the lacking data. The information collection part 13 associates the collected data, identification information, and reception date and time, and saves them in the storage part 16 as collected information 16b. When saving the collected information 16b, the information collection part 13 may create processed data (not shown) by processing (average value calculation, integration, etc.) the collected data, and store the processed data by including the processed data in the collected information 16b.

The evaluation processing part 14 is a function part that evaluates the collected information 16b based on the evaluation criteria information 16a (see FIG. 1). The evaluation processing part 14 may perform evaluation processing to give a level score corresponding to the numerical value of the data of the collected information 16b that corresponds to the evaluation items as to evaluation of evaluation items in which the evaluation method in the evaluation criteria information 16a is level (for example, see the “BCS score” column in FIGS. 3 and 5). As to evaluation of evaluation items for which the evaluation method in the evaluation criteria information 16a is OK/NG, the evaluation processing part 14 may perform evaluation processing to give OK/NG according to the data of the collected information 16b that corresponds to the evaluation items (for example, see “presence or absence of human stepping pan” column in FIGS. 3 and 5). The evaluation method in the evaluation criteria information 16a may be a sloped scoring method, mandatory/optional, etc. The evaluation processing part 14 saves the evaluation result 16c obtained by the evaluation process in the storage part 16 in association with the corresponding collected information 16b. In case that there is an evaluation item that does not satisfy the evaluation criteria in the evaluation result 16c, the evaluation processing part 14 may notify the evaluation item that does not satisfy the evaluation criteria to the field management system 40.

Here, the evaluation result 16c is a result obtained by the evaluation process of the collected information 16b. As shown in FIG. 5, the evaluation result 16c can be a result associated with individual identification number, producer identification number, score for each evaluation item (in FIG. 5, “BCS score”, “presence or absence of human stepping”, etc.), or OK/NG.

The information provision part 15 is a function part that provides the collected information 16b and the evaluation results 16c to the viewing terminal 80 (see FIG. 1). When receiving viewing request information from the viewing terminal 80 (searching by individual identification number, producer identification number, etc.), the information provision part 15 transmits the collected information 16b corresponding to the viewing request information to the viewing terminal 80. The information provision part 15 may comprise an information visualization part 15a that visualizes the collected information 16b and the evaluation results 16c. For example, upon a request from the viewing terminal 80, the information visualization part 15a may create visualized information as shown in FIG. 6 by calculating and graphing (for example, radar charting) a score for each of animal-base, facility-base, and management-base using a preset calculation formula based on the evaluation result 16c related to an arbitrary individual identification number in the collected information 16b and transmit the visualized information to the viewing terminal 80. The visualization information is not limited to a graph as shown in FIG. 6 but may also use a chart. Also, the visualization information may be information obtained by converting the evaluation result of any base only into a bar graph for each evaluation item; information obtained by converting any evaluation item in the evaluation result into a line graph for chronological order (for example, a chronological order using the date and time of reception); or information visualized by line plotting, bubble plotting, integrating data of arbitrary items, adding a moving average line or a spool line, etc.

The storage part 16 is a function part that stores various data (see FIG. 1). The storage part 16 stores the evaluation criteria information 16a (see, for example, FIG. 3) created by the evaluation criteria creation part 12. The storage part 16 stores the collected information 16b (for example, see FIG. 4) obtained by integrating data collected by the information collection part 13. The storage part 16 stores the evaluation result 16c (for example, see FIG. 5) evaluated by the evaluation processing part 14 in association with the corresponding collected information 16b. The storage part 16 may store the evaluation method data 31 acquired in the past together with the date and time of acquisition. The storage part 16 may store evaluation criteria information 16a created in the past together with creation date and time.

The storage part 16 may store keywords obtained through machine learning when creating the evaluation criteria information 16a. The storage part 16 may store the collected information 16b for each identification information created for past viewing, together with the creation date and time (the actual acquisition date and time of the data of the collected information 16b is also possible). The storage part 16 may store visualization information that was created by the information visualization part 15a in the past.

Here, the collected information 16b is information that integrates various data relating to the evaluation target object (for example, the health, breeding, environment, etc. of domestic animals). For example, as to domestic animals, the collected information 16b is information recording the backstory of domestic animals. The collected information 16b includes identification information (e.g., individual identification number, producer identification number, etc.). For example, as shown in FIG. 4, the collected information 16b can be information managed by individual identification number for each individual domestic animal:

managed by producer identification number for each producer; and managed for each date and time of data received from the field management system 40. For example, the collected information 16b can be information obtained by classifying information into animal-base, facility-base, and management-base, as shown in FIG. 4, in accordance with evaluation method of animal welfare; and organizing various details data relating to the health, breeding, environment, etc. of domestic animals for each base.

The management terminal 20 is a terminal used by the administrator of the evaluation apparatus 10 (see FIG. 1). The management terminal 20 is communicably (wireless-communicably, wired-communicably) connected to the evaluation apparatus 10 via a network 90. As the management terminal 20, a terminal (computer terminal) comprising function parts that configure a computer (for example, a processor, a storage device, an input device, a communication interface, and a display device) can be used and, a personal computer, a server, a tablet terminal, a smartphone, etc. can be used. The management terminal 20 can manage (input, create, delete, add, change, edit, etc.) information in the evaluation apparatus 10 through operations of the administrator. There may be more than one management terminal 20.

The evaluation method provision apparatus 30 is an apparatus that provides standardized evaluation method data 31 (for example, see FIG. 2) created by an international organization, public organization, etc. (see FIG. 1). As the evaluation method provision apparatus 30, for example, a server apparatus comprising a computer including a processor, a memory, a network interface, etc. can be used. The evaluation method provision apparatus 30 is communicably (wireless-communicably, wired-communicably) connected to the evaluation apparatus 10 via a network 90. The evaluation method provision apparatus 30 stores evaluation method data 31. The evaluation method provision apparatus 30 transmits evaluation method data 31 to the evaluation apparatus 10 in response to a request from the evaluation apparatus 10. There may be not only one evaluation method provision apparatus 30, but also a plurality of evaluation method provision apparatuses.

The field management system 40 is a system that manages information relating to an evaluation target object (for example, a domestic animal, etc.) at a field (see FIG. 1). The field management system 40 can comprise, for example, a server apparatus 50, a sensor 60, a camera 61, a robot 62, a vendor terminal 70, and a local network 91.

The server apparatus 50 is an apparatus that manages information relating to the field (for example, domestic animals at the livestock site under its management) (see FIG. 1). As the server apparatus 50, for example, a server apparatus comprising a computer including a processor, a memory, a network interface, etc. can be used. The server apparatus 50 is communicably (wireless-communicably, wired-communicably) connected to the evaluation apparatus 10 via a network 90. The server apparatus 50 collects and stores data according to the collection items provided by the evaluation apparatus 10. Besides collecting data for evaluation, the server apparatus 50 may also collect and store data for ranch management or other purposes. The server apparatus 50 transmits the collected data to the evaluation apparatus 10. The server apparatus 50 has a clock function to manage date and time. The server apparatus 50 can be configured to virtually comprise a data management part 51, a communication part 52, and a storage part 53 by executing a program in a processor while using a memory.

The data management part 51 is a function part that manages data collected from the sensor 60, camera 61, robot 62, or vendor terminal 70 according to the collection items provided by the evaluation apparatus 10 (see FIG. 1). The data management part 51 controls the communication part 52 and the storage part 53. The data management part 51 acquires collection items provided from the evaluation apparatus 10 through the communication part 52 and stores the collection items in the storage part 53. The data management part 51 periodically (at any time is possible) collects data from the sensor 60, camera 61, robot 62, or vendor terminal 70 through the communication part 52 according to the collection items and stores the collected data in the section 53. The data management part 51 can perform n information processing (calculation processing, image processing, analysis processing, etc.) as to the collected data and store the processed data in the storage part 53. The data management part 51 periodically (at any time is possible) transmits the data (which may include processed data) stored in the storage part 53 to the evaluation apparatus 10 via the communication part 52.

The communication part 52 is a function part that performs communication (wired communication, wireless communication) through the network 90 and local network 91 (see FIG. 1). The communication part 52 receives the collection items provided from the evaluation apparatus 10 under the control of the data management part 51. The communication part 52 receives data from the sensor 60, camera 61, robot 62, or vendor terminal 70 under the control of the data management part 51. The communication part 52 transmits the data (which may include processed data) stored in the storage part 53 to the evaluation apparatus 10 under the control of the data management part 51.

The storage part 53 is a function part that stores various data (see FIG. 1). The storage part 53 stores the collection items provided from the evaluation apparatus 10 under the control of the data management part 51. The storage part 53 stores data collected from the sensor 60, camera 61, robot 62, or vendor terminal 70 according to the collection items under the control of the data management part 51. The storage part 53 may classify the collected data into, for example, animal base, facility base, and management base according to the collection items and organize and store various detailed data related to the health, breeding, environment, etc. of domestic animals for each base under the control of the data management part 51.

The sensor 60 is a function part that senses various data relating to the evaluation target object (for example, the health, breeding, environment, etc. of domestic animals) (see FIG. 1). The sensor 60 is communication, wireless communication) communicably (wired connected to the server apparatus 50 via a local network 91. The sensor 60 transmits sensed data (for example, temperature inside and outside the barn, humidity, illuminance, power consumption, water consumption, gas consumption, etc.) to the server apparatus 50. There may be not only one sensor 60, but also a plurality of sensors. Also, the sensor 60 may be omitted in case that the vendor uses the vendor terminal 70 to input data.

The camera 61 is a function part that captures various image data relating to the evaluation target object (for example, the health, breeding, environment, etc. of domestic animals) (see FIG. 1). The camera 61 is communicably (wired communication, wireless communication) connected to the server apparatus 50 via a local network 91. The camera 61 transmits captured image data (for example, images of domestic animals, images of barn, etc.) to the server apparatus 50. There may be not only one camera 61, but also a plurality of cameras. Also, the camera 61 may be omitted in case that the vendor uses the vendor terminal 70 to input image data.

The robot 62 is a function part that monitors various status data relating to the evaluation target object (for example, the health, breeding, environment, etc. of domestic animals) (see FIG. 1). The robot 62 is communicably (wired communication, wireless communication) connected to the server apparatus 50 via a local network 91. As the robot 62, for example, a moving body comprising a sensor or a camera, a drone, or the like can be used. The robot 62 transmits monitored state data (for example, sensing data of domestic animals, barn, etc. that require monitoring while moving, image data, etc.) to the server apparatus 50. The robot 62 may be used, for example, to take action on the field or give specific instructions to areas with poor evaluation results by operating the vendor terminal 70. There may be not only one robot 62, but also a plurality of robot. Also, the robot 62 may be omitted in case that the vendor uses the vendor terminal 70 to input status data.

The vendor terminal 70 is a terminal used by a vendor who manages the field management system 40 (see FIG. 1). The vendor terminal 70 is communicably (wireless-communicably, wired-communicably) connected to the server apparatus 50 via a local network 91. As the vendor terminal 70, a terminal (computer terminal) comprising function parts (for example, a processor, a storage device, an input device, a communication interface, and a display device) that configure a computer can be used, for example, a personal computer, a server, a tablet terminal, a smartphone, etc. can be used. The vendor terminal 70 can manage (input, create, delete, add, change, edit, etc.) information in the server apparatus 50 through the operations of vendor. In case that data is manually inputted because there is no sensor 60, camera 61, or robot 62 at the field, or in case that data (for example, the management status of bedding and feed, the health status of domestic animals, the breeding environment status such as odor, electronic medical records, injury status, disease status, therapy status, medication status, slaughter status, cleaning frequency or amount, physique, stress, etc.) cannot be acquired by the sensor 60, camera 61, or robot 62 is inputted, the vendor terminal 70 can input and transmit the data to the server apparatus 50 by the operations of vendor. There may be not only one vendor terminal 70, but also a plurality of vendor terminal.

The local network 91 is a communication network that performs communication (wired communication, wireless communication) in the local area between the server apparatus 50, the sensor 60, the camera 61, the robot 62, and the vendor terminal 70 in the field management system 40 (see FIG. 1). A part of local network 91 may include a wide area network. As the local network 91, for example, a communication network such as a PAN (Personal Area Network), a LAN (Local Area Network), a MAN (Metropolitan Area Network), a WAN (Wide Area Network), or a GAN (Global Area Network) can be used.

The viewing terminal 80 is a terminal used by the viewer when viewing the collected information 16b and the evaluation result 16c (see FIG. 1). The viewing terminal 80 is communicably (wireless-communicably, wired-communicably) connected to the evaluation apparatus 10 via a network 90. As the viewing terminal 80, a terminal (computer terminal) comprising function parts (for example, a processor, a storage device, an input device, a communication interface, and a display device) that configure a computer, for example, a personal computer, a server, a tablet terminal, a smartphone, etc. can be used. The viewing terminal 80 can acquire, display, and view the collected information 16b and the evaluation result 16c according to a request from the evaluation apparatus 10 through the operation of viewer. As the viewer, for example, a consumer, a wholesaler, a retailer, a food company, a domestic animal distributor, an animal welfare promoter, a university, a ministry, a retailer (supermarket, convenience store), a food and beverage company (restaurant, cake shop), a mail order company, a SNS (Social networking service) provider and a matching service provider can be included.

The network 90 is a communication network that performs communication (wired communication, wireless communication) in a wide area between the evaluation apparatus 10, the management terminal 20, the evaluation method provision apparatus 30, the field management system 40, and the viewing terminal 80. (See FIG. 1). As the network 90, for example, a communication network such as a PAN, LAN, MAN, WAN, or GAN can be used.

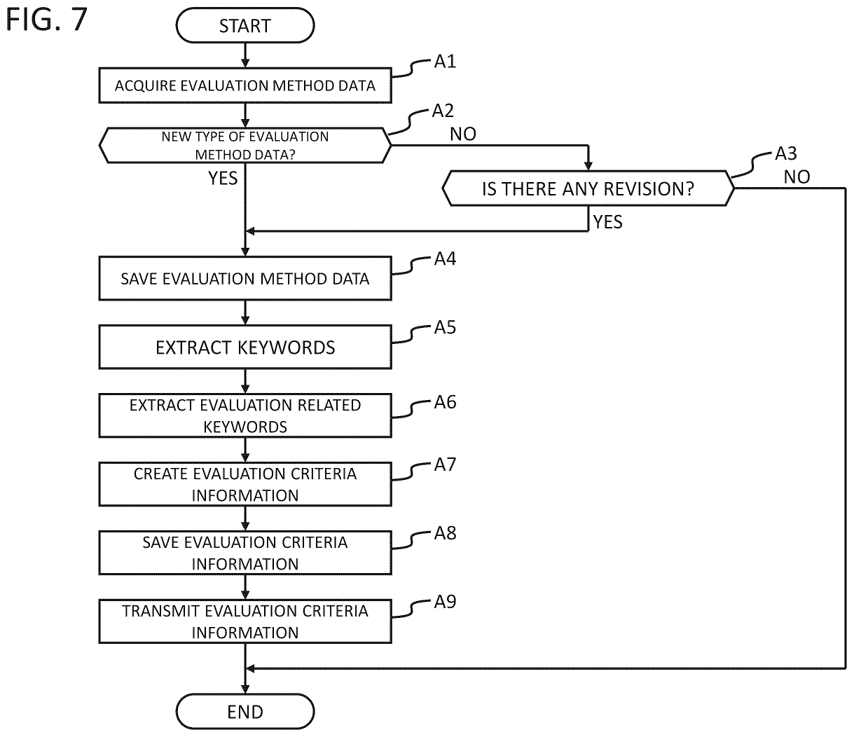

Operations of the information management apparatus in the evaluation system according to the example embodiment 1 will be explained. First, operations when creating the collection items will be explained using drawings. FIG. 7 is a flowchart schematically showing operations when creating evaluation criteria information by the evaluation apparatus in the evaluation system according to the example embodiment 1. Please see FIG. 1 as to the configuration of the evaluation system.

First, the evaluation method acquisition part 11 of the evaluation apparatus 10 accesses the evaluation method provision apparatus 30 and acquires the evaluation method data 31 from the evaluation method provision apparatus 30 (step A1).

Next, the evaluation method acquisition part 11 compares the acquired evaluation method data 31 with the evaluation method data acquired in the past (the stored latest evaluation method data) and determines whether the acquired evaluation method data 31 is evaluation method data of a new type or kind (e.g., domestic animal species not found in past evaluation method data) (step A2). In case that the evaluation method data is a new (YES in step A2), the process proceeds to step A4.

In case that the evaluation method data is the same type (NO in step A2), the evaluation method acquisition part 11 compares the acquired evaluation method data 31 with the evaluation method data acquired in the past (the stored latest evaluation method data) and determines whether the acquired evaluation method data 31 has been revised (step A3). In case that the evaluation method data 31 has not been revised (NO in step A3), the process ends. In case that the evaluation method data 31 has been revised (YES in step A3), the process proceeds to step A4.

In case that the evaluation method data is a new type (YES in step A2), or in case that the evaluation method data 31 has been revised (YES in step A3), the evaluation method acquisition part 11 saves the acquired evaluation method data 31 in the storage part 16 (step A4).

Next, the evaluation criteria creation part 12 of the evaluation apparatus 10 extracts keywords from the acquired evaluation method data 31 (step A5).

Next, the evaluation criteria creation part 12 extracts evaluation related keywords from the extracted keywords based on preset criteria (step A6). Upon extracting evaluation related keywords, evaluation related keywords are extracted from the keywords extracted in step A5 based on criteria relating to evaluation related keywords stored through machine learning. In case that there is a keyword that does not correspond to any of the evaluation related keywords stored through machine learning in the keywords extracted in step A5, it is also possible to notify to the management terminal 20 used by the administrator of the evaluation apparatus 10 that there is a keyword that does not correspond to any of the evaluation related keywords: ask the administrator to extract evaluation related keywords from the keywords that does not correspond to any of the evaluation related keywords; and extract the evaluation related keywords by obtaining the evaluation related keywords extracted by the administrator from the management terminal 20.

Next, the evaluation criteria creation part 12 creates evaluation criteria information 16a based on the extracted evaluation related keywords (step A7). The evaluation criteria information 16a may be created by organizing evaluation items in accordance with the data configuration of the acquired evaluation method data 31.

Next, the evaluation criteria creation part 12 saves the created evaluation criteria information 16a in the storage part 16 (step A8).

Next, the evaluation criteria creation part 12 transmits the created evaluation criteria information 16a to the server apparatus 50 of the field management system 40 (step A9), and then the process ends.

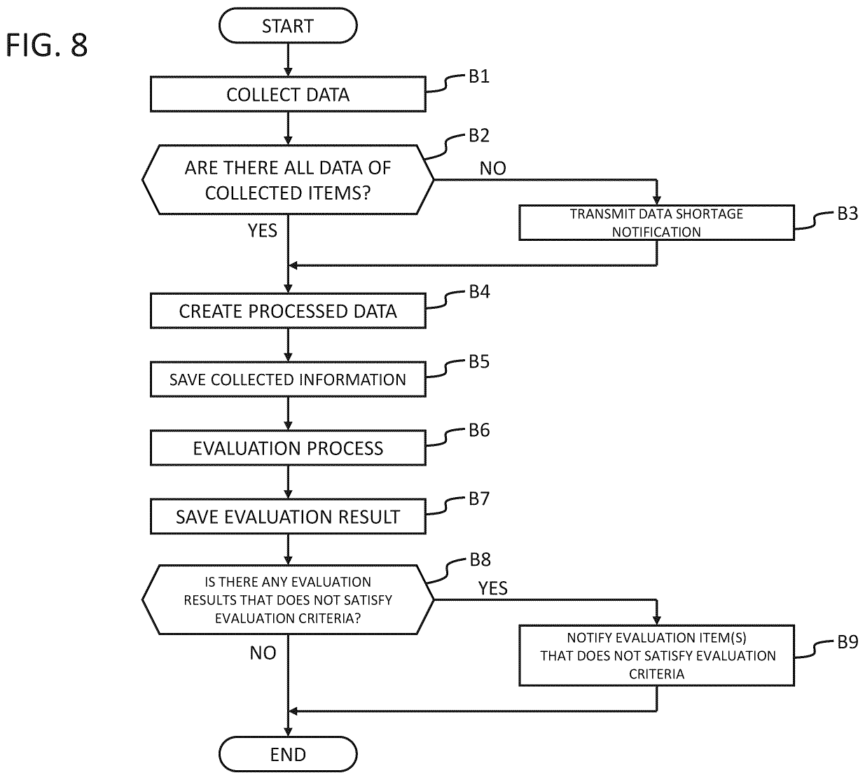

Next, operations when performing data collection and evaluation processing will be explained using drawings. FIG. 8 is a flowchart schematically showing operations when data collection and evaluation processing are performed by the evaluation apparatus in the evaluation system according to the example embodiment 1. Please see FIG. 1 as to the configuration of the evaluation system.

First, the information collection part 13 of the evaluation apparatus 10 collects data corresponding to preset collection items from the field management system 40 (step B1).

Next, the information collection part 13 determines whether all data of the collection items are included in the collected data (step B2). In case that all data is included (YES in step B2), the process proceeds to step B4.

In case that all data are not included (NO in step B2), the information collection part 13 transmits a data shortage notification (including the lacking data items) for notifying that there is a data shortage in the collected data to the field management system 40 (step B3), and then proceeds to step B4. Thereby, the vendor can know the lacking data through the vendor terminal 70 of the field management system 40, and the vendor can collect the lacking data and provide the lacking data to the evaluation apparatus 10.

In case that all data are included (YES in step B2), or after step B3, the information collection part 13 creates processed data (for example, an average value, an integrated value, etc.) obtained by processing predetermined data in the collected data based on preset conditions. (step B4). In case that there is shortage in data, processing data is not created and step B4 is skipped.

Next, the information collection part 13 saves collected information 16b, which integrates the collected data (including, for example, individual identification number, producer identification number, and date and time of receipt) and processed data, in the storage part 16 (step B5). In case of shortage in data, the collected information 16b is saved in the storage part 16 in a state that data remains in shortage without processed data.

Next, the evaluation processing part 14 of the evaluation apparatus 10 evaluates the collected information 16b based on the evaluation criteria information 16a (step B6).

Next, the evaluation processing part 14 saves the evaluation result 16c obtained by the evaluation process in association with the corresponding collected information 16b in the storage part 16 (step B7). Upon saving the evaluation result 16c, it is saved in association with the evaluation method data 31 and the evaluation criteria information 16a, which are the basis of the evaluation process, and it may be possible to view the evaluation result 16c on the viewing terminal 80 with reference to the evaluation method data 31 and the evaluation criteria information 16a.

Next, the evaluation processing part 14 determines whether or not there is an evaluation item that does not satisfy the evaluation criteria in the evaluation result 16c (step B8). In case that there is no evaluation item that does not satisfy the evaluation criteria (NO in step B8), the process ends.

In case that there is an evaluation item that does not satisfy the evaluation criteria (YES in step B8), the evaluation processing part 14 notifies the field management system 40 of the evaluation item that does not satisfy the evaluation criteria (step B9), and then the process ends.

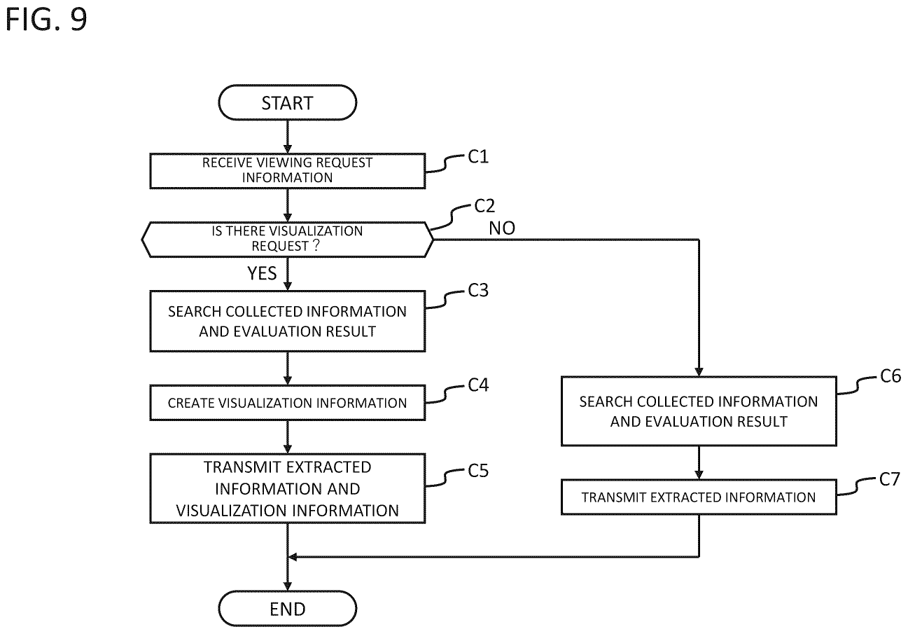

Next, operations when providing (viewing) collected information and evaluation results will be explained using drawings. FIG. 9 is a flowchart schematically showing operations when information is provided by the evaluation apparatus in the evaluation system according to the example embodiment 1.

First, the information provision part 15 of the evaluation apparatus 10 receives viewing request information (for example, information requesting a search by individual identification number, producer identification number, period, etc.) from the viewing terminal 80 (step C1).

Next, the information provision part 15 determines whether or not there is a visualization request in the received viewing request information (step C2). In case that there is no visualization request (NO in step C2), the process proceeds to step C6.

In case that there is a visualization request (YES in step C2), the information provision part 15 searches the collected information 16b and evaluation results 16c based on the received viewing request information (step C3).

Next, the information visualization part 15a of the information provision part 15 creates visualization information (for example, a graph) based on the information extracted by the search (step C4).

Next, the information provision part 15 transmits the information extracted by the search and the created visualization information to the viewing terminal 80 (step C5), and then the process ends. Thereby, the extracted information and the created visualization information can be viewed on the viewing terminal 80.

In case that there is no visualization request (NO in step C2), the information provision part 15 searches the collected information 16b and the evaluation results 16c based on the received viewing request information (step C6).

Next, the information provision part 15 transmits the information extracted by the search to the viewing terminal 80 (step C7), and then the process ends. Thereby, the extracted information can be viewed on the viewing terminal 80.

According to the example embodiment 1, since the collected information 16b is evaluated based on the evaluation criteria information 16a created by acquiring the evaluation method data 31, it is possible to contribute to conducting evaluation corresponding to a demand of changing standardized evaluation method.

Also, according to the example embodiment 1, since it is possible to determine whether or not the system corresponds to a demand of standardized evaluation method by simply checking the evaluation results automatically processed by the system, it is possible to reduce effort and cost of evaluation and certification for vendors.

Further, according to the example embodiment 1, since the evaluation apparatus 10 can output the evaluation result 16c in real time, the viewer of the evaluation result 16c can confirm whether or not it corresponds to a standardized evaluation method.

Further, according to the example embodiment 1, in order to create the evaluation criteria information 16a based on the latest standardized evaluation method data 31 that is changing and notify the evaluation criteria information 16a to the field management system 40 (vendor), it becomes possible to review the configuration of the field management system 40 so as to correspond to the standardized evaluation method.

Further, according to the example embodiment 1, the administrator (operator) of the evaluation apparatus 10 always automatically performs evaluation processing to determine whether the system corresponds to a demand of standardized evaluation method and when the evaluation criteria is not satisfied, the field management system 40 (vendor) is notified of this fact, so the vendor can grasp a point to be improved and a point to be prioritized and it becomes possible to maintain operations (raising, transporting, slaughtering, etc.) in accordance with the standardized evaluation method.

Further, according to the example embodiment 1, in case of handling information relating to domestic animals, it is possible to output evaluation results 16c based on a wide variety of evaluation criteria information 16a in the standardized evaluation method, so it is possible to check not only a farm, but also transportation from the farm to a slaughterhouse, furthermore a status of slaughter methods.

Further, according to the example embodiment 1, in case of handling information relating to domestic animals, the evaluation apparatus 10 can output the evaluation results 16c for each domestic animal individually or output the evaluation results 16c for each breed or type of domestic animal, so it becomes possible to check the total number of domestic animals without any hassle.

Further, according to the example embodiment 1, in case of handling information relating to domestic animals, the field management system 40 (vendor) can certify that the domestic animals comply with the criteria of the standardized evaluation method through the evaluation result 16c, so it is possible to reduce effort and cost of certification.

Further, according to the example embodiment 1, in case of handling information relating to domestic animals, domestic animals related transportation companies and slaughterhouses can determine whether or not the animal should be transported or slaughtered according to the evaluation results based on the standardized evaluation method by viewing the evaluation results of the evaluation apparatus 10 and select the method of transportation or slaughter, and it is possible to reduce effort and cost of certification.

Furthermore, according to the example embodiment 1, in case of handling information relating to domestic animals, processors, retailers, and consumers search by producer identification information or individual identification number and view the evaluation results, thereby it is possible to know whether or not the target domestic animal is a meat obtained from a vendor that satisfies the criteria of a standardized evaluation method, so it is possible to ensure the safety of the meat and improve the feeling of security before purchasing.

### Example Embodiment 2

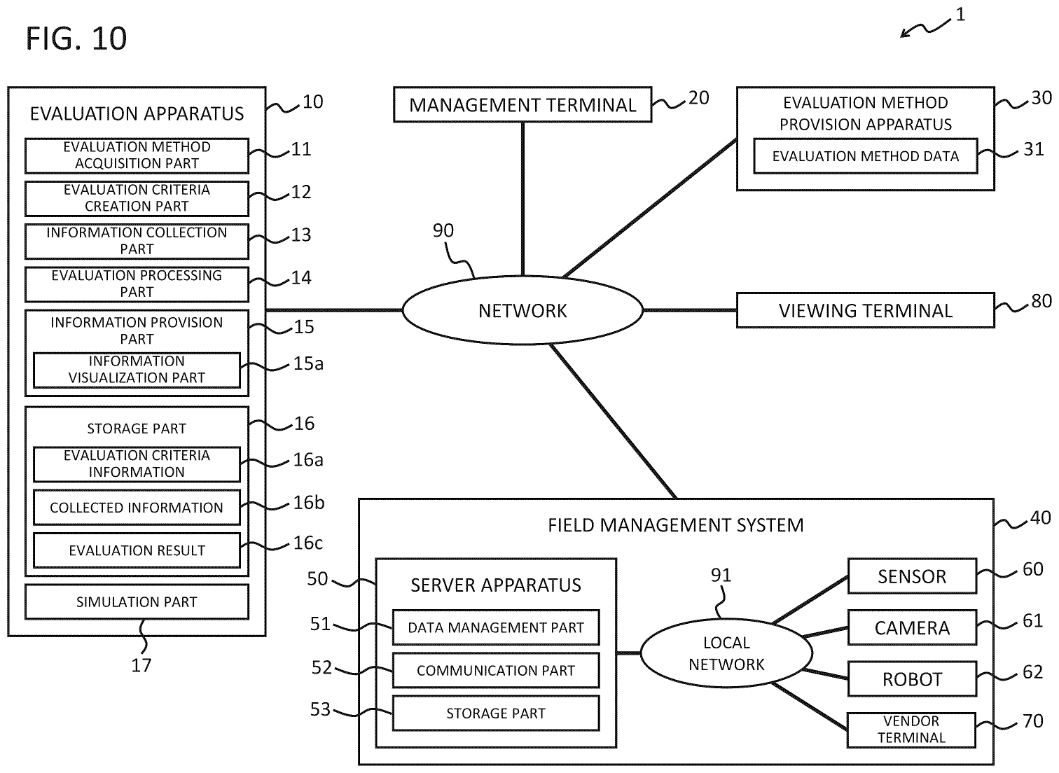

An evaluation system according to the example embodiment 2 will be explained using drawings. FIG. 10 is a block diagram schematically showing a configuration of the evaluation system according to the example embodiment 2.

The example embodiment 2 is a modification of the example embodiment 1, in which a simulation part 17 is added to the evaluation apparatus 10. A vendor who is an administrator of the field management system 40 inputs virtual information (such as data included in the collected information 16b) from the vendor terminal 70, thereby the simulation part 17 simulates whether or not the input virtual information satisfies the criteria of the evaluation standard information 16a: creates a simulation result; and transmits the simulation result to the vendor terminal 70. As a result, the vendor can refer to the simulation results on the vendor terminal 70. Although the example embodiment 2 has a configuration in which the simulation part 17 is comprised, the operation of the simulation part 17 may be performed by the evaluation processing part 14 without providing the simulation part 17. As a result, the simulation result of the evaluation can be known by simply giving the evaluation processing part 14 an artificially changed value and then performing the evaluation normally. The simulation may be performed not only for all evaluation items of the evaluation criteria information 16a but also for at least one specific evaluation item (for example, BCS (Body Condition Score) score, etc.). The other configurations of the example embodiment 2 are similar to those of the example embodiment 1.

According to the example embodiment 2, similarly to the example embodiment 1, it is possible to contribute to conducting evaluation corresponding to a demand of changing standardized evaluation method, and a vendor refers to simulation results before formal evaluation and understands how to satisfy the criteria of standardized evaluation method, so it is possible to improve the value of each vendor's final products and services and contribute to a spread of system. Also, by providing the simulation part 17, it becomes possible to simulate a plurality of evaluations classified into cases based on the conditions in the evaluation criteria. In the example of BCS scores, it is possible to output simulation results of evaluation based on evaluation criteria information by specifying one BCS score or leaving it blank among all collection items necessary for evaluation.

### Example Embodiment 3

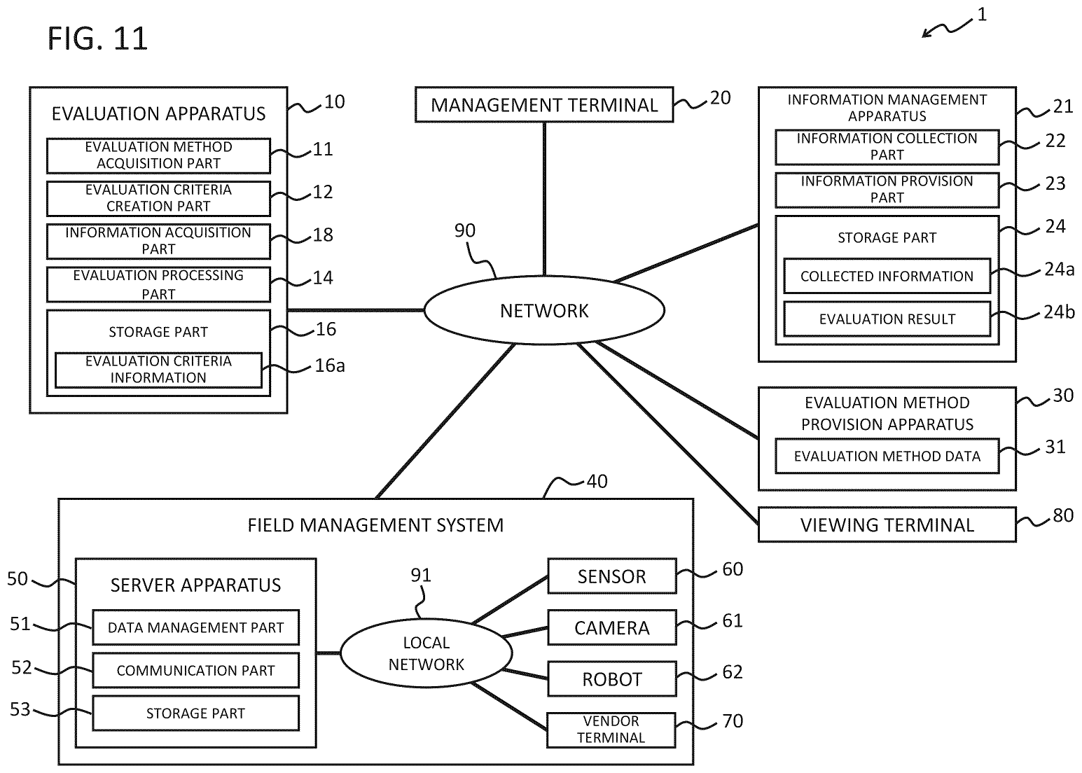

An evaluation system according to the example embodiment 3 will be explained using drawings. FIG. 11 is a block diagram schematically showing a configuration of the evaluation system according to the example embodiment 3.

The example embodiment 3 is a modification of the example embodiment 1. In the example embodiment 3, an information management apparatus 21 is provided by extracting (removing) the information management (collection, provision) function from the evaluation apparatus (10 in FIG. 1) of the example embodiment 1. As the information management function has been extracted from the evaluation apparatus 10, an information acquisition part 18 is provided in the evaluation apparatus 10.

The evaluation apparatus 10 is an apparatus that evaluates a state relating to the evaluation target object (for example, a domestic animal, etc.) (see FIG. 11). The evaluation apparatus 10 acquires the evaluation method data 31 from the evaluation method provision apparatus 30, and creates the evaluation criteria information 16a based on the acquired evaluation method data 31. The evaluation apparatus 10 does not collect data relating to the evaluation target object from the field management system 40 but acquires the collected information 24a (information collected from the field management system 40) from the information management apparatus 21. The evaluation apparatus 10 creates an evaluation result 24b of the acquired collected information 24a based on the created evaluation criteria information 16a. The evaluation apparatus 10 transmits the created evaluation result 24b to the information management apparatus 21 without storing the evaluation result 24b in itself. As the evaluation apparatus 10, for example, a server apparatus comprising a computer including a processor, a memory, a network interface, etc. can be used. The evaluation apparatus 10 is communicably (wireless-communicably, wired-communicably) connected to the management terminal 20, the information management apparatus 21, the evaluation method provision apparatus 30, the field management system 40, and the viewing terminal 80 via the network 90. The evaluation apparatus 10 can be formed of a configuration that virtually comprises an evaluation method acquisition part 11, an evaluation criteria creation part 12, an information acquisition part 18, an evaluation processing part 14, and a storage part 16, by executing a program in a processor while using memory. The evaluation apparatus 10 may comprise a simulation part (17 in FIG. 10).

The evaluation method acquisition part 11 is similar to the evaluation method acquisition part (11 in FIG. 1) of the example embodiment 1 but may transmit the collected evaluation method data 31 to the information management apparatus 21 to store the evaluation method data 31 therein. The evaluation criteria creation part 12 is similar to the evaluation criteria creation part (12 in FIG. 1) of the example embodiment 1, but may transmit the created evaluation criteria information to the information management apparatus 21 and store the evaluation criteria information therein. As to the evaluation processing part 14, the evaluation result 24b obtained by the evaluation process is not stored in the storage part 16 (although it may be stored) but may be transmitted to the information management apparatus 21 and stored therein, and others than these are similar to the evaluation processing part (14 in FIG. 1) of the example embodiment 1. As to the storage part 16, the collected information 24a and the evaluation results 24b are not stored (although it may be stored) in itself, and others than that are similar to the storage part (16 in FIG. 1) of the example embodiment 1. The collected information 24a (information similar to the collected information 16b in FIG. 1) and the evaluation result 24b (result similar to the evaluation result 16c in FIG. 1: visualization information of the evaluation result 24b may also be included) are stored in the information management apparatus 21. All information provided from the information management apparatus 21 to the viewing terminal 80 is stored in the information management apparatus 21. Although the evaluation apparatus 10 does not comprise an information collection part 22 and an information provision part 23, the information management apparatus 21 comprises an information collection part 22 and an information provision part 23.

The information acquisition part 18 is a function part that acquires the collected information 24a from the information management apparatus 21 (see FIG. 11). The information acquisition part 18 transmits the acquired collected information 24a to the evaluation processing part 14. The information acquisition part 18 may cause the storage part 16 to store the acquired collected information 24a. The information management apparatus 21 is an apparatus that manages the collected information 24a and the evaluation results 24b thereof (see FIG. 11). The information management apparatus 21 provides a scheme for utilizing the collected information 24a and the evaluation results 24b thereof. The information management apparatus 21 collects and integrates data corresponding to preset collection items and stores the integrated collected information 24a. The information management apparatus 21 provides the stored collected information 24a to the evaluation apparatus 10: acquires the evaluation result 24b of the collected information 24a from the evaluation apparatus 10; and stores the evaluation result 24b in the storage part 24 in association with the collected information 24a. The information management apparatus 21 allows the viewing terminal 80 to view the collected information 24a and the evaluation results 24b. As the information management apparatus 21, for example, a server apparatus comprising a computer including a processor, a memory, a network interface, etc. can be used. The information management apparatus 21 is communicably (wireless-communicably, wired-communicably) connected to the evaluation apparatus 10, the management terminal 20, the evaluation method provision apparatus 30, the field management system 40, and the viewing terminal 80 via a network 90. The information management apparatus 21 has a clock function that manages date and time. The information management apparatus 21 can be a configuration that virtually comprises an information collection part 22, an information provision part 23, and a storage part 24 by executing a program in a processor while using memory. The information management apparatus 21 may have a distributed configuration on a cloud. The information collection part 22 and the information provision part 23 are similar to the information collection part (13 in FIG. 1) and the information provision part (15 in FIG. 1) of the example embodiment 1. The storage part 24 does not store the evaluation criteria information 16a and others than this is similar to the storage part (16 in FIG. 1) of the example embodiment 1. In the example embodiment 3, although the information management apparatus 21 has a function of providing information for viewing, the information providing function of the information management apparatus 21 is not used and the information for viewing may be stored in the evaluation apparatus 10 to provide information for viewing.

According to the example embodiment 3, similarly to the example embodiment 1, it is possible to contribute to conducting evaluation corresponding to a demand of changing standardized evaluation method, and even when the evaluation apparatus 10 is performing maintenance, the information providing service (viewing service) on the information management apparatus 21 can be continued. Also, by separating the evaluation apparatus 10 from the information management apparatus 21, security can be ensured.

### Example Embodiment 4

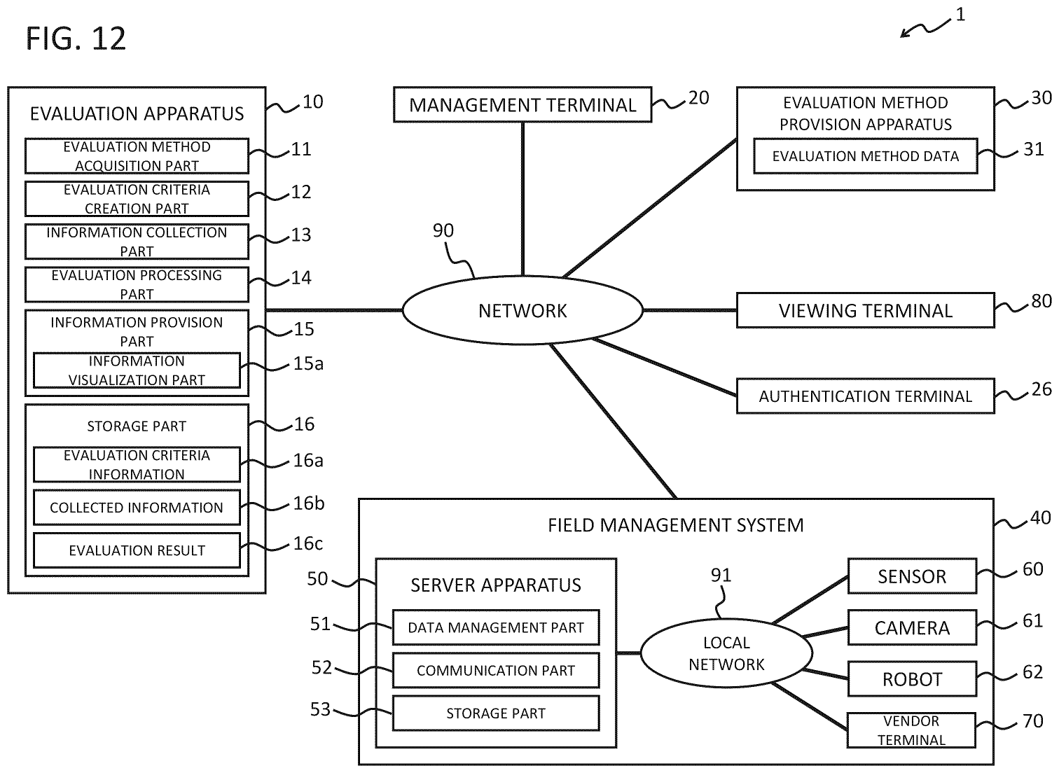

An evaluation system according to the example embodiment 4 will be explained using drawings. FIG. 12 is a block diagram schematically showing a configuration of the evaluation system according to the example embodiment 4.

The example embodiment 4 is a modification of the example embodiment 1, in which a certification body or certifier as a third-party uses an authentication terminal 26 to authenticate the evaluation result 16c evaluated by the evaluation apparatus 10. Instead of the authentication terminal 26, an authentication server that automatically performs authentication processing may be used. The configuration other than the authentication terminal 26 is similar to that of the example embodiment 1 (see FIG. 1). Also, the example embodiment 4 may be applied to the example embodiment 2 or the example embodiment 3.

The authentication terminal 26 is a terminal used by a certification body (for example, a public institution) or a certifier (for example, a certification qualification holder) to authenticate the collected information 16b and the evaluation result 16c (see FIG. 12). The authentication terminal 26 is communicably (wireless-communicably, wired-communicably) connected to the evaluation apparatus 10 via a network 90. As the authentication terminal 26, a terminal (computer terminal) comprising function parts (for example, a processor, a storage device, an input device, a communication interface, and a display device) that configure a computer can be used, for example, a personal computer, a server, a tablet terminal, a smartphone, etc. can be used. The authentication terminal 26 performs authentication by acquiring and displaying the collected information 16b and the evaluation result 16c of the evaluation apparatus 10 through the operation of the certification body or certifier. Authentication of the collected information 16b and the evaluation results 16c may be performed, for example, by storing authentication identification information issued by the certification body or certifier in the evaluation apparatus 10 in association with the collected information 16b and the evaluation results 16c.

According to the example embodiment 4, similarly to the example embodiment 1, it is possible to contribute to conducting evaluation corresponding to a demand of changing standardized evaluation method, by authenticating the collected information 16b and the evaluation result 16c by the certification body or certifier, a reliability of the collected information 16b and the evaluation result 16c can be further improved. In particular, in case of handling information relating to domestic animals, when processors, retailers, and consumers view the information on the evaluation apparatus 10, by referring to the authentication identification information, it is possible to know whether or not the target domestic animal is a meat obtained from a certified vendor that follows a standardized evaluation method, so guaranteeing the safety of meat and feeling of security can be improved.

### Example Embodiment 5

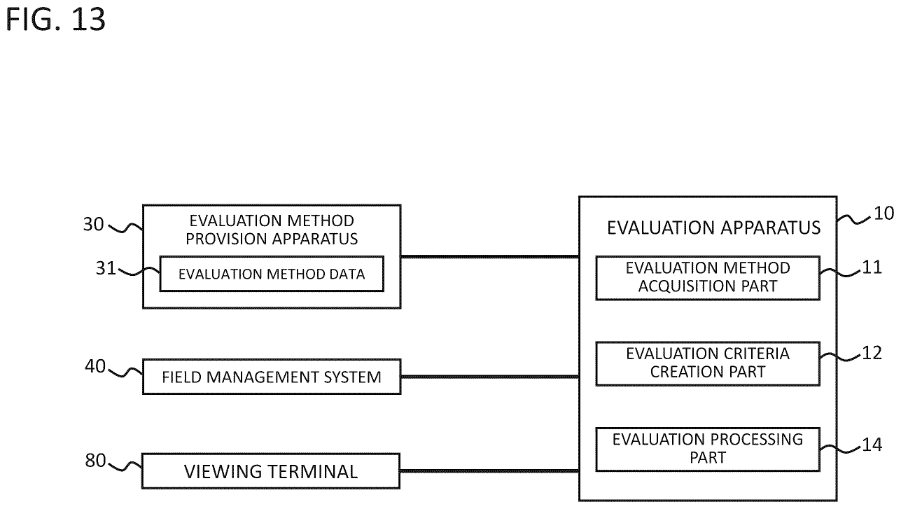

An evaluation apparatus according to the example embodiment 5 will be explained using drawings. FIG. 13 is a block diagram schematically showing a configuration of the evaluation apparatus according to the example embodiment 5.

The evaluation apparatus 10 is an apparatus that evaluates a state of evaluation target object (see FIG. 13). The evaluation apparatus 10 comprises an evaluation method acquisition part 11, an evaluation criteria creation part 12, and an evaluation processing part 14. The evaluation method acquisition part 11 is configured to acquire evaluation method data 31 from an evaluation method provision apparatus 30. The evaluation criteria creation part 12 is configured to create evaluation criteria information for evaluating collected information that integrates data collected from a field management system 40 that manages field information based on the evaluation method data 31. The evaluation processing part 14 is configured to evaluate the collected information based on the evaluation criteria information and create an evaluation result.

According to the example embodiment 5, since the collected information is evaluated based on the evaluation criteria information created by acquiring the evaluation method data 31, it is possible to contribute to conducting evaluation corresponding to a demand of changing standardized evaluation method.

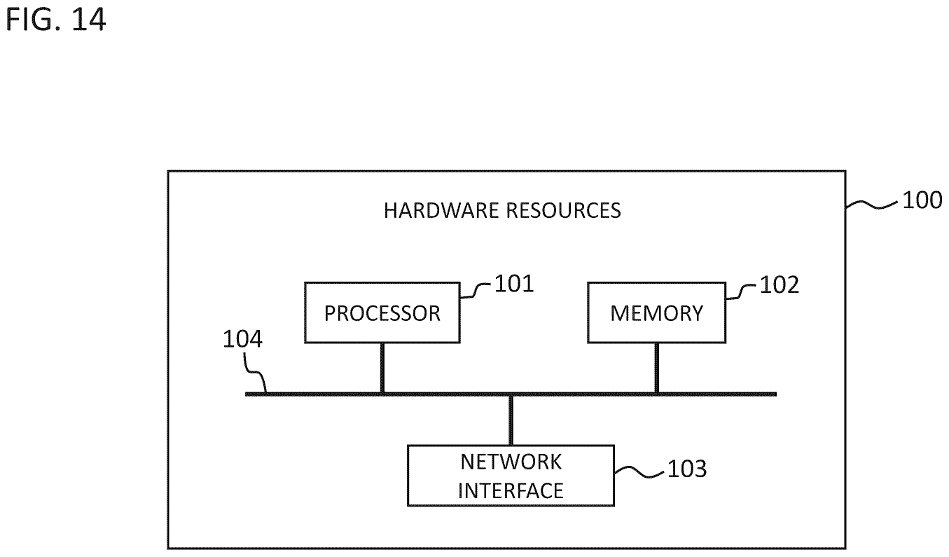

The evaluation apparatus, the management terminal, the evaluation method provision apparatus, viewing terminal, server apparatus, and vendor terminal according to the example embodiments 1 to 5, can be configured by so-called hardware resources (information processing apparatus, computer), and can be an apparatus comprising the configuration shown exemplarily in FIG. 14. For example, the hardware resources 100 comprise a processor 101, a memory 102, and a network interface 103, etc., which are interconnected by an internal bus 104.

The configuration shown in FIG. 14 is not intended to limit the hardware configuration of the hardware resources 100. The hardware resource 100 may include hardware (for example, an input/output interface) that is not shown. Alternatively, the number of units such as the processors 101 included in the apparatus is not limited to the example shown in FIG. 14: for example, a plurality of processors 101 may be included in the hardware resources 100. As the processor 101, for example, a CPU (Central Processing part), an MPU (Micro Processor Unit), a GPU (Graphics Processing part), etc. can be used.

As the memory 102, for example, RAM (Random Access Memory), ROM (Read Only Memory), HDD (Hard Disk Drive), SSD (Solid State Drive), etc. can be used.

As the network interface 103, for example, a LAN (Local Area Network) card, a network adapter, a network interface card, etc. can be used.

The functions of the hardware resources 100 are realized by the processing modules described above. The processing module is realized, for example, by the processor 101 executing a program stored in the memory 102. Also, the program can be updated by downloading over a network or by using a storage medium storing the program. Further, the processing module may be realized by a semiconductor chip. That is, the functions performed by the processing module may be able to be realized by executing software on some kind of hardware.

A part or all of the above example embodiments may be described as the following modes but is not limited to the following.

### [Mode 1]

An evaluation apparatus comprising:
an evaluation method acquisition part configured to acquire evaluation method data from an evaluation method provision apparatus;
an evaluation criteria creation part configured to create evaluation criteria information for evaluating collected information that integrates data collected from a field management system that manages field information based on the evaluation method data; and
an evaluation processing part configured to evaluate the collected information based on the evaluation criteria information and create an evaluation result.

### [Mode 2]

The evaluation apparatus according to Mode 1, further comprising a simulation part configured to simulate whether or not virtual information from the field management system satisfies criteria of the evaluation criteria information, create a simulation result, and transmit the simulation result to the field management system.

### [Mode 3]

The evaluation apparatus according to Mode 1 or 2, further comprising an information acquisition part configured to acquire the collected information from an information management apparatus that manages the collected information,
wherein the evaluation processing part is configured to evaluate the acquired collected information based on the evaluation criteria information, create the evaluation result, and transmit the evaluation result to the information management apparatus.

### [Mode 4]

The evaluation apparatus according to Mode 1 or 2, further comprising:
an information collection part configured to collect the data from the field management system based on preset collection items;
a storage part configured to store the collected information obtained by integrating the collected data in association with the evaluation result; and
an information provision part configured to, when receiving viewing request information from a viewing terminal, extract information corresponding to the viewing request information from the collected information or the evaluation result, and transmit the extracted information to the viewing terminal.

### [Mode 5]

The evaluation apparatus according to Mode 4,
wherein the information provision part is configured to: execute processings:
when there is a visualization request in the viewing request information, searching for the collected information or the evaluation result based on the viewing request information; and creating visualization information based on the information extracted by the search; and
transmitting the collected information or the evaluation result extracted by the search and the created visualization information to the viewing terminal.

### [Mode 6]

The evaluation apparatus according to any one of Modes 1 to 5,
wherein the evaluation method acquisition part is configured to compare the evaluation method data acquired currently with evaluation method data acquired in the past, and, in case that the evaluation method data acquired currently is a new type of evaluation method data, or in case that the evaluation method data acquired currently has been revised, save the currently acquired evaluation method data; and
wherein the evaluation criteria creation part is configured to create the evaluation criteria information based on the currently acquired evaluation method data when the currently acquired evaluation method data is saved.

### [Mode 7]

The evaluation apparatus according to any one of Modes 1 to 6, wherein the evaluation criteria creation part is configured to execute processings:
extracting keywords from the acquired evaluation method data;
extracting keywords related to evaluation from the extracted keywords based on preset criteria; and creating the evaluation criteria information based on the extracted keywords related to the evaluation.

### [Mode 8]

An evaluation system comprising:
the evaluation apparatus according to any one of Modes 1, 2, 4 to 6 or 7,
a field management system that manages field information and is communicably connected to the evaluation apparatus;
an evaluation method provision apparatus that provides evaluation method data and is communicably connected to the evaluation apparatus; and
a viewing terminal communicably connected to the evaluation apparatus.

### [Mode 9]

An evaluation system comprising:
the evaluation apparatus according to any one of Modes 1 to 3, 6 or 7; an information management apparatus that manages the collected information and is communicably connected to the evaluation apparatus;
a field management system that manages field information and is communicably connected to the information management apparatus;
an evaluation method provision apparatus that provides evaluation method data and is communicably connected to the evaluation apparatus; and
a viewing terminal communicably connected to the information management apparatus.

### [Mode 10]

The evaluation system according to Mode 8 or 9, further comprising an authentication terminal or an authentication server that executes authentication processing on the evaluation result and is communicably connected to the evaluation apparatus.

[Mode 11]

An evaluation method of evaluating collected information using hardware resources, comprising:
acquiring evaluation method data from an evaluation method provision apparatus;
creating evaluation criteria information for evaluating collected information that integrates data collected from a field management system that manages field information based on the evaluation method data; and
evaluating the collected information based on the evaluation criteria information to create an evaluation result.

### [Mode 12]

A program that causes hardware resources to execute processings for evaluating collected information,
wherein the program that causes the hardware resources to execute processings;
acquiring evaluation method data from the evaluation method provision apparatus;
based on the evaluation method data, creating evaluation criteria information for evaluating collected information that integrates data collected from a field management system that manages field information; and
evaluating the collected information based on the evaluation criteria information to create an evaluation result.

Modes 11 and 12 can be expanded like Modes 2 to 7.

It should be noted that each disclosure of the above PTLs and NPTL shall be incorporated and described herein by reference and can be used as a basis or a part of the present invention as necessary. Within a framework of the entire disclosure of the present invention (including claims and drawings), it is possible to modify or adjust the example embodiments or examples based on the basic technical idea thereof. Also, within the framework of entire disclosure of the present invention, various combinations or selections (non-selection if necessary) of various disclosed elements (including each element of each claim, each element of each example embodiment or example, each element of each drawing, etc.) is possible. That is, it goes without saying that the present invention includes various modifications and modifications that can be made by one skilled in the art in accordance with all disclosures including claims and drawings, and the technical concept. Further, as to the numerical values and numerical ranges described in the present application, it is considered that arbitrary intermediate values, lower numerical values, and small ranges are described even if not explicitly recited. Furthermore, it is also considered that a matter used to combine part or all of each of the disclosed matters of the above-cited documents with the matters described in this document as a part of the disclosure of the present invention, in accordance with the gist of the present invention, if necessary, is included in the disclosed matters of the present application.

### REFERENCE SIGNS LIST

1 Evaluation system
10 Evaluation apparatus
11 Evaluation method acquisition part
12 Evaluation criteria creation part
13 Information collection part
14 Evaluation processing part
15 Information provision part
15a Information visualization part
16 Storage part
16a Evaluation criteria information
16b Collected information
16c Evaluation result
17 Simulation part
18 Information acquisition part
20 Management terminal
21 Information management apparatus
22 Information collection part
23 Information provision part
24 Storage part
24a Collected information
24b Evaluation result
26 Authentication terminal
30 Evaluation method provision apparatus
31 Evaluation method data
40 Field management system
50 Server apparatus
51 Data management part
52 Communication part
53 Storage part
60 Sensor
61 Camera
62 Robot
70 Vendor terminal
80 Viewing terminal
90 Network
91 Local network
100 Hardware resources
101 Processor
102 Memory
103 Network interface
104 Internal bus

What is claimed is:

1. An evaluation apparatus, comprising:
an evaluation method acquisition part configured to acquire evaluation method data from an evaluation method provision apparatus;
an evaluation criteria creation part configured to create evaluation criteria information for evaluating collected information that integrates data collected from a field management system that manages field information based on the evaluation method data; and
an evaluation processing part configured to evaluate the collected information based on the evaluation criteria information and create an evaluation result.

2. The evaluation apparatus according to claim 1, further comprising a simulation part configured to simulate whether or not virtual information from the field management system satisfies criteria of the evaluation criteria information, create a simulation result, and transmit the simulation result to the field management system.

3. The evaluation apparatus according to claim 1, further comprising an information acquisition part configured to acquire the collected information from an information management apparatus that manages the collected information,
wherein the evaluation processing part is configured to evaluate the acquired collected information based on the evaluation criteria information, create the evaluation result, and transmit the evaluation result to the information management apparatus.

4. The evaluation apparatus according to claim 1, further comprising:
an information collection part configured to collect the data from the field management system based on preset collection items;
a storage part configured to store the collected information obtained by integrating the collected data in association with the evaluation result; and
an information provision part configured to, when receiving viewing request information from a viewing terminal, extract information corresponding to the viewing request information from the collected information or the evaluation result, and transmit the extracted information to the viewing terminal.

5. The evaluation apparatus according to claim 4,
wherein the information provision part is configured to: execute processings:
when there is a visualization request in the viewing request information, searching for the collected information or the evaluation result based on the viewing request information; and creating visualization information based on the information extracted by the search; and
transmitting the collected information or the evaluation result extracted by the search and the created visualization information to the viewing terminal.

6. The evaluation apparatus according to claim 1,
wherein the evaluation method acquisition part is configured to compare the evaluation method data acquired currently with evaluation method data acquired in the past, and, in case that the evaluation method data acquired currently is a new type of evaluation method data, or in case that the evaluation method data acquired currently has been revised, save the currently acquired evaluation method data; and
wherein the evaluation criteria creation part is configured to create the evaluation criteria information based on the currently acquired evaluation method data when the currently acquired evaluation method data is saved.

7. The evaluation apparatus according to claim 1,
wherein the evaluation criteria creation part is configured to execute processings:
extracting keywords from the acquired evaluation method data;
extracting keywords related to evaluation from the extracted keywords based on preset criteria; and
creating the evaluation criteria information based on the extracted keywords related to the evaluation.

8. An evaluation system comprising:
the evaluation apparatus according to claim 1;
a field management system that manages field information and is communicably connected to the evaluation apparatus;
an evaluation method provision apparatus that provides evaluation method data and is communicably connected to the evaluation apparatus; and
a viewing terminal communicably connected to the evaluation apparatus.

9. An evaluation system comprising:
the evaluation apparatus according to claim 1;
an information management apparatus that manages the collected information and is communicably connected to the evaluation apparatus;
a field management system that manages field information and is communicably connected to the information management apparatus;
an evaluation method provision apparatus that provides evaluation method data and is communicably connected to the evaluation apparatus; and
a viewing terminal communicably connected to the information management apparatus.

10. The evaluation system according to claim 8, further comprising an authentication terminal or an authentication server that executes authentication processing on the evaluation result and is communicably connected to the evaluation apparatus.

11. An evaluation method of evaluating collected information using hardware resources, comprising:
acquiring evaluation method data from an evaluation method provision apparatus;
creating evaluation criteria information for evaluating collected information that integrates data collected from a field management system that manages field information based on the evaluation method data; and
evaluating the collected information based on the evaluation criteria information to create an evaluation result.

12. A non-transitory computer readable recording medium storing a program that causes hardware resources to execute processings for evaluating collected information,
wherein the program that causes the hardware resources to execute-processings:
acquiring evaluation method data from the evaluation method provision apparatus;
based on the evaluation method data, creating evaluation criteria information for evaluating collected information that integrates data collected from a field management system that manages field information; and
evaluating the collected information based on the evaluation criteria information to create an evaluation result.

13. The evaluation apparatus according to claim 2, further comprising an information acquisition part configured to acquire the collected information from an information management apparatus that manages the collected information,
wherein the evaluation processing part is configured to evaluate the acquired collected information based on the evaluation criteria information, create the evaluation result, and transmit the evaluation result to the information management apparatus.

14. The evaluation apparatus according to claim 2, further comprising:
an information collection part configured to collect the data from the field management system based on preset collection items;
a storage part configured to store the collected information obtained by integrating the collected data in association with the evaluation result; and
an information provision part configured to, when receiving viewing request information from a viewing terminal, extract information corresponding to the viewing request information from the collected information or the evaluation result, and transmit the extracted information to the viewing terminal.

15. The evaluation apparatus according to claim 14,
wherein the information provision part is configured to: execute processings:
when there is a visualization request in the viewing request information, searching for the collected information or the evaluation result based on the viewing request information; and creating visualization information based on the information extracted by the search; and
transmitting the collected information or the evaluation result extracted by the search and the created visualization information to the viewing terminal.

16. The evaluation apparatus according to claim 2,
wherein the evaluation method acquisition part is configured to compare the evaluation method data acquired currently with evaluation method data acquired in the past, and, in case that the evaluation method data acquired currently is a new type of evaluation method data, or in case that the evaluation method data acquired currently has been revised, save the currently acquired evaluation method data; and
wherein the evaluation criteria creation part is configured to create the evaluation criteria information based on the currently acquired evaluation method data when the currently acquired evaluation method data is saved.

17. The evaluation apparatus according to claim 3,
wherein the evaluation method acquisition part is configured to compare the evaluation method data acquired currently with evaluation method data acquired in the past, and, in case that the evaluation method data acquired currently is a new type of evaluation method data, or in case that the evaluation method data acquired currently has been revised, save the currently acquired evaluation method data; and
wherein the evaluation criteria creation part is configured to create the evaluation criteria information based on the currently acquired evaluation method data when the currently acquired evaluation method data is saved.

18. The evaluation apparatus according to claim 4,
wherein the evaluation method acquisition part is configured to compare the evaluation method data acquired currently with evaluation method data acquired in the past, and, in case that the evaluation method data acquired currently is a new type of evaluation method data, or in case that the evaluation method data acquired currently has been revised, save the currently acquired evaluation method data; and
wherein the evaluation criteria creation part is configured to create the evaluation criteria information based on the currently acquired evaluation method data when the currently acquired evaluation method data is saved.

19. The evaluation apparatus according to claim 5,
wherein the evaluation method acquisition part is configured to compare the evaluation method data acquired currently with evaluation method data acquired in the past, and, in case that the evaluation method data acquired currently is a new type of evaluation method data, or in case that the evaluation method data acquired currently has been revised, save the currently acquired evaluation method data; and
wherein the evaluation criteria creation part is configured to create the evaluation criteria information based on the currently acquired evaluation method data when the currently acquired evaluation method data is saved.

20. The evaluation apparatus according to claim 2,
wherein the evaluation criteria creation part is configured to execute processings:
extracting keywords from the acquired evaluation method data;
extracting keywords related to evaluation from the extracted keywords based on preset criteria; and
creating the evaluation criteria information based on the extracted keywords related to the evaluation.
